(19) United States
(12) Patent Application Publication
(10) Pub. No.: US 2009/0094460 A1
(43) Pub. Date: Apr. 9, 2009

(54) Method and system for signer self-managed, encryption-based identification and signature secret management to verify signer and to legitimize basic digital signature without the use of certificates, tokens or PKI (private key infrastructure)

(76) Inventor: Radim Dedek, Valencia, CA (US)

Correspondence Address: DEDEK CONSULTING CORP., 13636 VENTURA BLVD., # 278, SHERMAN OAKS, CA, 91354, US

(21) Appl. No.: 11/973,841

(22) Filed: Oct. 9, 2007

(51) Int. Cl. H04L 9/00

(52) U.S. Cl. 713/180

(57) ABSTRACT

Method and system for signer self-managed, encryption-based identification and signature secret management to verify the signer and to legitimize basic electronic signature without the use of certificates, tokens or PKI while signing electronic document off-line, on-line (corporate network) or on-line using a web based document. When form is completed, the signing procedure is intercepted by the software to check if signer secret and signer information is present on signer device, else the signer can enter required information and additional system information is gathered. The signature information is validated against the stored encrypted signer information. Both the signature ceremony and the encrypted signer secrets and identification information are embedded in the document for delivery to document recipient. The signer's secret is never compromised, as it is at all times created or updated by signer via self-management software and never revealed to an administrator.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM

Not Applicable

### FIELD OF THE INVENTION

The invention is directed toward the field of computer or digital processing systems related to providing means of document signer identification, legitimization and securing techniques of electronic signature using encryption with the purpose to exchange legitimized information/document data between several independent source(s) and document recipient computer(s) going forward and without the need of pre-created certificates, tokens or access to document recipient network or information.

### BACKGROUND OF THE INVENTION

Presently there are several different technologies supporting signature ceremonies to sign documents and provide signer verification at the time of signing.

On the high end of the electronic signature security scale are the highly secure technologies requiring (a) many steps for a signer to request and create an authentication secret associated with key or token based technologies; (b) on-line access to infrastructure on intended information recipient's network (examples: PKI-private key infrastructure, certificate based signing, custom only on-line technologies, authentication of user based on previously supplied information or tokens from intended recipient to verify such signer); (c) administration personnel to manage the underlying infrastructure of passwords, private and public keys, installations and setups. In most cases there is a need to have commercial certificates on a signer device where signing is to take place to authenticate the signature. In all cases a signer must have access to or be a part of complex supporting infrastructure which is difficult to maintain, difficult to keep up to date and most of the time such certificates expire causing additional difficulties and complexities verifying validity of signatures and signer on older documents. As a side issue, the security of PKI, certificate or on-line signer authentication systems may be compromised, because managers of such complex infrastructures are required to create certificate/secrets or on-line system signer verification passwords and provide them to signer during installation/setup to keep complexity away from users. These high-end, and therefore very secure and valid, signature authentication solutions are geared toward large organizations with much of the needed infrastructure and layers of system administration already in place.

The smaller organizations may not have the resources available to set up such complex solutions or larger organizations do not want to create additional complex private key based infrastructures. To minimize the on-line access requirement and infrastructure management and signer verification obstacles at the time of signing, many implemented solutions fall back on the basic non-secured, non-verified clickwrap-like or similar unprotected electronic signing technologies where signer provides any personal information to identify itself. The non-secure signature signing is on the opposite end of the electronic signature signing scale from the certificate-based signature authentication methods.

During clickwrap-like or similar non-secure signing, signer enters information (any information, sometimes in duplicate) to validate signature and identify itself. Such method of signing cannot be protected or signer validated at the time of signing. It is the law in the United States that electronic signatures carry the same legal effect as a handwritten signature provided in the “old-fashioned” manner by the use of pen and ink in interstate and international commerce, with certain exceptions (See the Electronic Signatures in Global and National Commerce Act, Public Law 106-229 (2000)). A submitted electronic form signed in this informal fashion cannot be linked, re-used or verified to its signer with any level of confidence, and therefore, may be worthless. This method of electronic form signing, consequently, is not suitable for any applications requiring a level of assurance as to the identity of the signer.

The clickwrap-like or similar non-secured signer signing does not provide security of the signature itself and verification of signer because there are no PKI, certificates or on-line access to recipient's network involved in this type of signing. Resulting document and data is then processed by recipient (when received by document delivery methods not in scope of this invention) without assurance of the signer identity, thus without ability to prove the signer of received document and data. Thus there is no guarantee of non-repudiation of the signature/signer and also data using clickwrap-like or similar non-secured signing technologies.

The invention fills the void in the middle ground between the two ends of the electronic signature spectrum. Until now, there has been no simple signer self-managed technology where administrator(s) or other personnel are not involved in secret/certificate creation and maintenance/handling. There are also no commercial medium security, simple to use, manage and maintain signer validation technology alternatives available for signer validation during signing. Only (a) high end, highly secure, predefined token/key based, but complex methods associated with PKI and certificate based signer authentication/verification and (b) low end, non-secure, non-verifiable clickwrap-like or similar non-secure signer methods are available.

The invention offers medium-level of electronic signature security, yet easy to maintain, without the need for complex infrastructure, administration or signer needing access to document recipient network. It secures signature and verifies a signer signing electronic documents using clickwrap-like or similar signing technologies at the time of document signing, without the necessity for PKI, signing certificate or any other requirements such as on-line access to network storage or previously supplied information or tokens from intended recipient.

The normally completely non-secure clickwrap-like signing activity is intercepted by the invention, and identity of the signer is established, based on several criteria, along with signer self-given secret, that is encrypted and stored as part of document for transmission at the completion of document. The encrypted signer secret ends up automatically on signer device and also in a secure location on document recipient network for any additional electronic re-validation of signer (if required) as additional verification prior to final processing of received information signed using clickwrap-like or similar non-secure signing method. Thus signers manage their own secrets, without the need for administrators to issue and manage any certificates or tokens. If recipient provides access to such signer if appropriate, signer can manage through the invention software signer secret and information also on-line and software ensures both recipient network and signer information on signer's device are synchronized for off-line signing. Signatures thus submitted never expire (a common annual expiration issue with certificates), and the signer's identity is preserved long into the future.

### BRIEF SUMMARY OF THE INVENTION

This invention provides medium security, but secure and easy to maintain and manage alternative signer verification technology.

It is a system, infrastructure, method and encrypted signature secret and identification information management to secure a digital signature and verify a signer signing electronic documents using clickwrap-like or similar signing technologies at the time of document signing, without the need for PKI, signing certificates, or any other requirements such as on-line access to network storage or previously supplied information or tokens from the intended recipient.

The invention software provides on-line, off-line and internet DMZ or non-DMZ device based signer verification using a signer created/maintained, encrypted signer secret and identification information verified at the time of document signing where clickwrap-like or similar non-secure signing technology is used.

The encrypted signer secret and identification information can be created by a signer at the time of the first off-line, on-line or internet DMZ or non-DMZ device based clickwrap-like based or similar non-secure signing session and the encrypted signer secret stored on signer device can be re-used by the signer for future signing.

The signer verification can happen while using off-line device, internet DMZ device, on-line device or internet non-DMZ device.

If signer has on-line or internet non-DMZ access (not required) to recipient's network storage, through automated encrypted signature secret management a signer can create or modify current encrypted signer secret and identification information to easily update and receive the new encrypted signer secret with identification information to use for on-line or off-line clicwrap-like or similar non-secure signing.

In both on-line, off-line or internet device signing cases the encrypted signer secret and identification information ends up automatically in secure location on document recipient network storage for any additional electronic re-validation of signer (if required) as additional verification prior to final processing of received information signed using clickwrap-like or similar non-secure signing method.

### BRIEF DESCRIPTION OF THE DRAWINGS

FIG. 1 is a diagram of an embodiment of the system of the present invention

FIG. 1A is a diagram of the setup of the present invention (minimal off-line and internet DMZ device configuration).

FIG. 1B is a diagram of the setup of the present invention (full off-line and internet DMZ device configuration)

FIG. 1C is a diagram of the optional on-line setup of the present invention (minimal on-line and internet non-DMZ device configuration)

FIG. 1D is a diagram of the optional on-line setup of the present invention (full on-line and internet non-DMZ device configuration)

FIG. 2 is a detailed diagram of the signer device 100 or 106 functionality and components

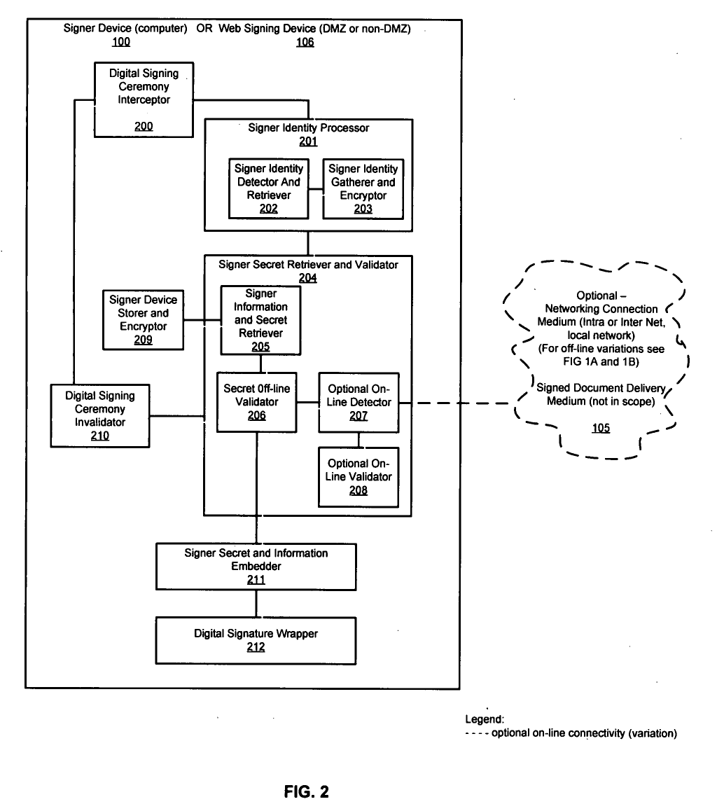

FIG. 3 is a detailed diagram of the recipient device 101 setup and recipient's administration of information

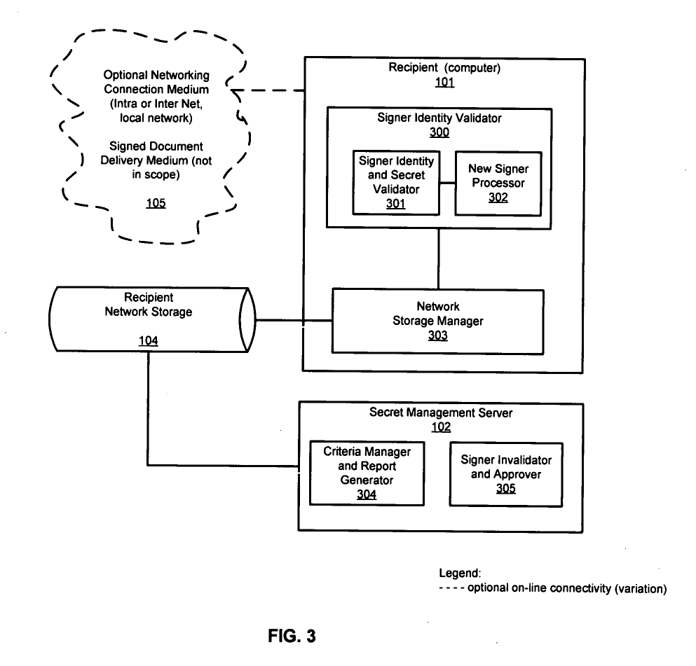

FIG. 4 is a diagram of signer device 100 and on-line and internet non-DMZ access to signer info and secret self management

### DETAILED DESCRIPTION OF THE INVENTION

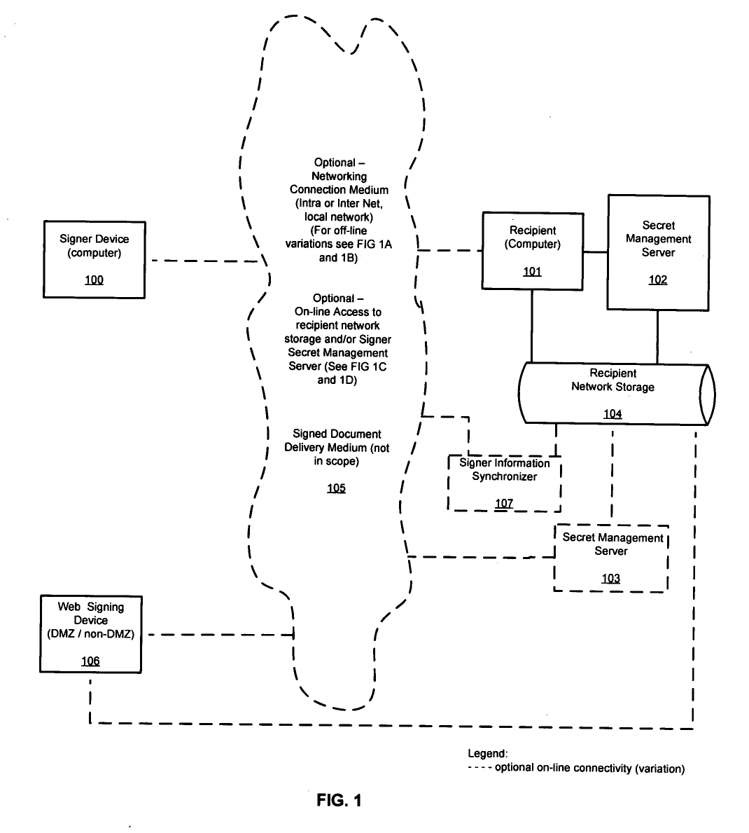

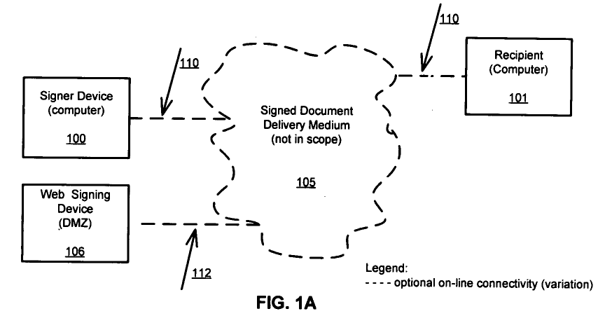

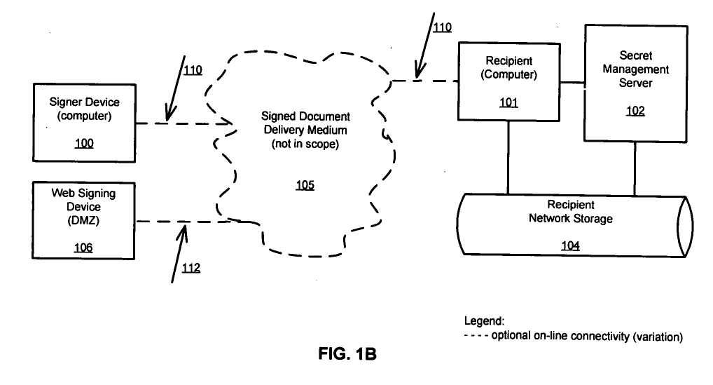

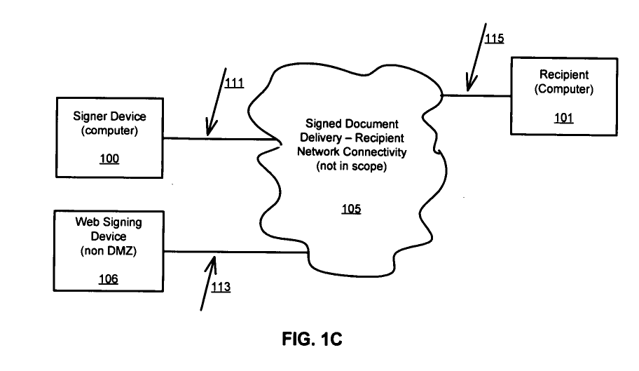

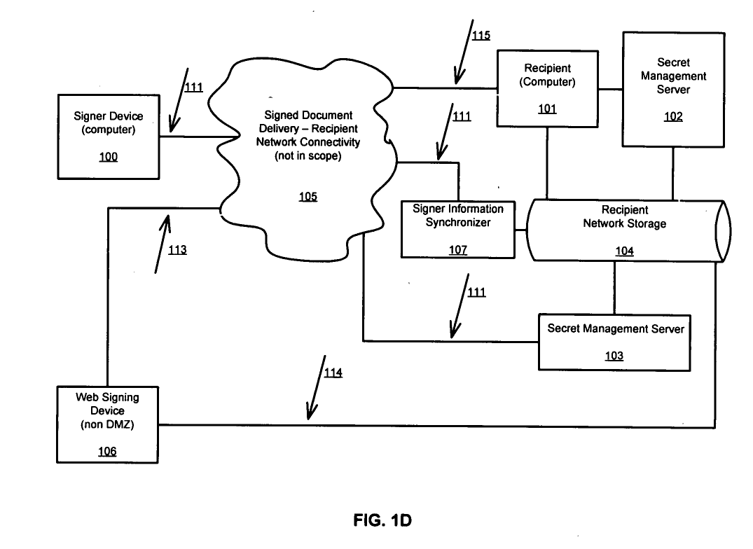

The invention provides unique medium-security, secure and easy to manage and maintain alternative electronic signer verification technology. It is a system, infrastructure, method and encrypted signature secret management to secure a digital signature and verify a signer signing electronic documents using clickwrap-like (or similar open source digital signature signing ceremony typically utilized by electronic form or document software as a base for signing and securing user entered document content—while the description of invention describes use of invention software with clickwrap-like signing example(s), it should be noted that “clickwrap-like” assumes also any other non-secured signing ceremonies similar to clickwrap) signing technologies without the need for PKI, signing certificates, or any other requirements such as on-line access to network storage or previously supplied information or tokens from the intended recipient. The system overview is shown in FIG. 1.

The invention provides electronic signer verification using a signer self-created, encrypted signer secret and identification information verified at the time of document signing using clickwrap-like or similar non-secure signing. Signing can take place in the following environments:
1. off-line (See FIGS. 1A and 1B)
2. on-line (See FIGS. 1C and 1D)
3. using internet in a DMZ configuration (See FIGS. 1A and 1B) (DMZ, where device renders electronic form or a document externally or internally but the device has no connection to recipient network storage or information on the network. DMZ is demilitarized zone/neutral zone)
4. using internet in a non-DMZ configuration (See FIGS. 1C and 1D) where the device has on-line access to recipient network storage and information

The invention technology is also used to secure and wrap clickwrap-like or similar non-secure signature using the encrypted signer secret (212) and manage digital signature deletion action by intercepting and clearing any validation or signature wrapping information (210).

The invention software is independently installed (a) off-line on signer device (100) (or other device) or (b) on internet DMZ device (106) where electronic document signing would take place. The software is configured to work with and intercept (200) the non-secure digital signing ceremony used in electronic form or document. The electronic document software installation, electronic documents and invention software installation are all supplied to signer for off line installation or used for installation by recipient on internet DMZ device. There is no PKI, tokens or any other embedded information in the electronic document software, the electronic documents or the invention software. The scope of the invention software does not include electronic forms/document software, electronic document structure or a specific signature ceremony.

When the document signing ceremony is in progress or completed (off-line device or internet DMZ device) the invention software intercepts (200) the signing ceremony to validate (206) the signer and secure the electronic signature (212).

There are several possible scenarios. The main off-line device and internet DMZ device signing invention capability is covered in Scenario One (see FIGS. 1A and 1B).

Scenario Two describes optional extended functionality to allow the same signer self-managed pre-identification on recipient network (103) (400) (401), if signer access is provided based on the business-set rules. In such a case, the invention software enables the signer to skip several steps during the first time off-line device use during document signing (described in Scenario One).

Additional on-line device and internet non-DMZ device (optional) capabilities and compatibilities of the invention software are described after the Scenario Two description (see FIGS. 1C and 1D).

Scenario One: all necessary software, documents and invention software is assumed to be installed on the signer device (100) or internet DMZ device (106).

The electronic form or document is completed and ready to be digitally signed on a disconnected off-line device (100) or on a recipient internet DMZ device (106).

The clickwrap-like signing ceremony is intercepted (200) during or at completion of signing by the invention software installed on the signer's device (100).

If the invention software does not detect existing local encrypted secret for the signer (202) (first time use), it prompts the signer to create a new signer secret (203). The invention software directs the signer to identify itself (203) (by entry of mandatory email address, and other information). At the same time, the invention software also gathers other available signer/device/system information (203) such as account name etc. for additional signer identification information and security.

The invention software stores and maintains securely encrypted (209) signer secret and identification information on the signer's device after the first session for future signer validations.

There are two common configurations of the signing ceremony. In the first, the repeat signer will enter the signer secret during the signing ceremony. The invention software will intercept and retrieve (200) the signer secret from digital signature for use in validation. In the second configuration, the signer does not enter the secret during the signature ceremony, the signer will be prompted to enter a signer secret when the signing ceremony is intercepted (200) by invention software.

The entered signer secret is validated (206) against the encrypted signer secret newly created secret if it is first time use or existing secret stored encrypted on the local device if this is not the first time signing.

When the entered signer secret and the encrypted stored signer secret do not match, the digital signature is invalidated or deleted (210) by the invention software and an error message is returned to the signer.

If the entered signer secret and the encrypted stored signer secret are matching, the entered signer secret is encrypted and both secrets are embedded (211) in the document for delivery to the recipient including additional encrypted signer identification information.

The digital signature itself is wrapped and secured (212) by the invention software using the encrypted signer secret. If a signature is later deleted by signer for any reason, the signature wrapper, encrypted signer secret and any verification is also removed (210) and the digital signing can be repeated again.

The recipient, upon receipt of the signed form or document (method of document receipt such as email (105) or other electronic transfer (105) of signed document delivery is not in scope of this invention) would have the same invention software pre-installed on his/her device 101 (laptop, desktop computer etc.). When the document with the embedded encrypted signer secret and identification information is opened by the recipient, the invention software allows the recipient to add (302) the encrypted signer secret and identification information into network storage (303) (files, database etc.) if the information does not already exist (can be optional).

Stored encrypted signer secret and identification information on the recipient's network (303) can also be used at this time by the installed invention software to re-validate (301) any received forms or documents from the same signer based on the encrypted signer secret and identification information (can be optional).

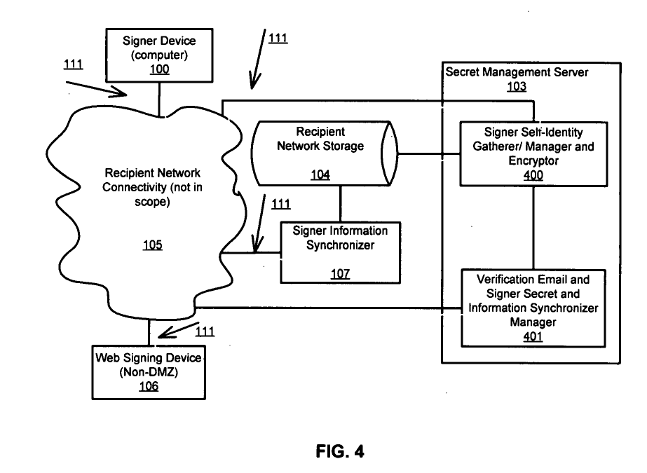

Scenario Two: the signer has access to and can work on the recipient's network (See FIG. 1C, FIG. 1D and FIG. 4 including all (111) arrows indicating on-line connections, internet non-DMZ device which has full access to information on the network). The signer (100) and the recipient (101) can use the invention software functionality in the same way as under Scenario One, or, the signer (100) and the recipient (101) can use the invention software in the following optional on-line device scenario two variation (See FIG. 1C, FIG. 1D).

The signer uses encrypted signature secret management server software (103) (part of the invention software) to create encrypted signer secret (400) and identification information first on the recipient's network, prior to first-time actual use of the digital signature.

The invention software stores the encrypted signer secret (400) and identification information in the network storage (104) (file, database etc.).

The invention software sends verification email (401) to the signer (100). Embedded within that email is the ability to initiate the invention technology signer information synchronizer (107). The synchronizer retrieves from the network storage (104) encrypted signer secret and identification information and stores it on the signer's device (100) keeping the signer's device (100) or internet non-DMZ device (106) in synchronization with the self-managed signer information stored on the recipient's network (104).

The signer (100) proceeds to complete and digitally sign forms or documents as described in Scenario One, except there is no creation of signer secret and identification information (201) during first-time use on the signer's device, as the encrypted signer secret and identification information already exists and is stored on the signer's device (100) or the internet non-DMZ device (106).

The invention technology also has additional built-in and integrated non sequential functionality (aside from Scenarios One and Two) which resolves issues with the token based technologies as follows:
(a) The secret management server software (102) as part of the invention software allows the recipient to invalidate, retire and approve (305) any signer information and encrypted signer secret, if the information is stored in the recipient's network storage (104).
(b) The secret management server software (102) as part of the invention software allows the recipient to generate variety of reports (304) related to signer information or secret management. The signer secrets are always encrypted and protected for complete privacy with no exposure to the recipient or technology administrators. This part of invention addresses the potential issues with signer secret exposure to administrators in current complex certificate-based solutions.
(c) The secret management server software (103) as part of the invention software allows signers to completely self-maintain signer secrets and identification information for full security. Signer can expire (400) existing encrypted signer secret and/or create (400) new encrypted signer secret in the recipient's network storage (104). The invention software updates the expired signer information and secret with expiry date and updates the new signer secret with effective date and open expiry date. The expired encrypted signer secret continues to be valid for signatures with the date range from the date of creation of encrypted signer secret to the date of expiration/replacement of the encrypted signer secret. This invention feature addresses the issues with current certificate-based solutions where expired certificate causes signer validation problem on older documents.
(d) When signing ceremony is intercepted, the invention software recognizes if the signer has access to the recipient's network (207). As a configuration option, in addition to off-line validation described in Scenario One, the invention software may validate the encrypted entered signer secret on the device (100) against the encrypted signer secret (208) stored in the recipient's storage (104). The on-line (208) portion is executed only if the encrypted signer secret is stored by recipient (see FIG. 1A and FIG. 1C) in Scenario One and/or the secret was created on-line by signer using the secret management server software in Scenario Two (see FIG. 1D).

The invention software is built and is configurable to work with any electronic document/forms software, electronic document structure and signing ceremony.

It should also be noted that there may be slight variations in implementations from the description of the invention and variations may be made to this invention without departing from the principle of the invention.

I claim:

1. A method and system of creating, using, managing and administrating encrypted signer secret and identification information, verifying signer, securing and legitimizing electronic document digital signature during signing by enhancing basic and non-secured type of digital signing technology without any need for PKI infrastructure, signing certificate, on-line access to network storage or previously supplied information tokens from the intended document recipient, wherein the method and system is comprising of: creating, storing, encrypting and managing signer self-created secret and identification information on signer device and or in recipient network storage; gathering, storing, encrypting and managing additional device and system identification information in support of verification of signer and securing of digital signature; detecting existence of encrypted signer secret and information on signer device; retrieving and decrypting encrypted signer secret and identification information from signer device in support of verification of signer and securing of digital signature; utilizing encrypted signer secret and identification information for digital signature secret verification; obtaining and validating signer digital signature secret against the encrypted signer secret stored on signer device; utilizing encrypted signer secret and identification information for securing digital signature; intercepting and extending digital signature signing ceremony capability to validate signer secret and identification information on signer device; wrapping digital signature using the validated encrypted signer secret; embedding encrypted signer secret and identification information in the document for delivery to recipient; detecting, decrypting and validating encrypted signer secret and identification information embedded in the document when the document is opened by the recipient; adding encrypted signer secret and identification information embedded in the document into recipient network storage when document is opened by the recipient.

2. The method of claim 1, wherein flexible configuration interacts with different non-secured type digital signing technologies, any electronic documents and forms by means of intercepting and extending the digital signing ceremony to provide signer verification and to secure digital signature.

3. The method of claim 1, wherein signer device is an off-line device or internet DMZ device, and extended on-line device or internet non-DMZ device.

4. The method of claim 3, wherein on-line or internet non-DMZ device connection to recipient network with access to network information is detected for configurable on-line encrypted signer secret and identification information validation in addition to local signer off-line device validation.

5. The method of claim 1, wherein failure to detect existence of encrypted signer secret and identification information on signer device prompts signer to enter signer secret and identification information.

6. The method of claim 5, wherein additional signer identification information is gathered from signer device for identification purpose.

7. The method of claim 5, wherein gathered signer secret and identification information is encrypted and stored on the signer device for verification use.

8. The method of claim 1, wherein signer secret is entered as part of digital signing ceremony on signer device and used for validation against the stored encrypted signer secret.

9. The method of claim 8, wherein the digital signing ceremony does not require signer secret to be entered, signer is prompted for signer secret for validation against the stored encrypted signer secret.

10. The method of claim 1, wherein the signer device is on-line device or internet non-DMZ device with access to the document recipient network storage, the creating, encrypting, storing and managing signer secret and identification information takes place on recipient network or signer device.

11. The method of claim 10, wherein signer created or updated encrypted signer secret are valid for signer verification with the date range from the date of creation of new or replacement encrypted signer secret to the date of future replacement of the current encrypted signer secret without invalidating existing signed documents.

12. The method of claim 10, wherein the on-line creation or replacement of signer secret and identification information sends verification email to the signer with embedded mechanism to initiate synchronization of encrypted signer secret and identification information on signer device.

13. The method of claim 1, wherein signer secret management administration and reporting using stored signer identification information in document recipient network storage comprising of: invalidating or retiring one or group of current encrypted signer secrets in document recipient network storage; suspending one or group of current encrypted signer secrets in document recipient network storage; approving signer identification information in document recipient network storage; sending email to signers affected by administrative action; report console.
